(19) United States
(12) Patent Application Publication
(10) Pub. No.: US 2025/0260535 A1
(43) Pub. Date: Aug. 14, 2025

(54) METHODS AND APPARATUS FOR MULTI-TRP SRS ENHANCEMENTS IN TDD

(71) Applicant: INTERDIGITAL PATENT HOLDINGS, INC., Wilmington, DE (US)

(72) Inventors: Loic Canonne-Velasquez, Dorval (CA); Afshin Haghighat, Ile-Bizard (CA); Jonghyun Park, Syosset, NY (US); Moon IL Lee, Melville, NY (US); Virgil Comsa, Montreal (CA)

(73) Assignee: INTERDIGITAL PATENT HOLDINGS, INC., Wilmington, DE (US)

(21) Appl. No.: 18/857,044

(22) PCT Filed: Apr. 26, 2023
(86) PCT No.: PCT/US2023/019914

§ 371 Date: Oct. 15, 2024

Related U.S. Application Data
(60) Provisional application No. 63/334,994, filed on Apr. 26, 2022.
(60) Provisional application No. 63/422,666, filed on Nov. 4, 2022.

(51) Int. Cl. H04L 5/00; H04L 27/26

(52) U.S. Cl. CPC H04L 5/0051; H04L 27/2607; H04L 27/261; H04L 27/2656

(57) ABSTRACT

A method and a wireless transmit/receive unit (WTRU) for multiple transmission and reception point (mTRP) transmission may comprise a WTRU configured to receive configuration information indicating a sounding reference signal (SRS) resource set that includes at least one or more SRS resources, one or more SRS parameters, and one or more time-based patterns. The WTRU may be configured to receive an indication to activate a time-based pattern of the one or more time-based patterns. The WTRU may be configured to transmit a first SRS in a first time instance using a first SRS resource of the one or more SRS resources and a first SRS parameter of the one or more SRS parameters. The WTRU may be configured to transmit a second SRS in a second time instance that is different than the first time instance using the first SRS resource and a second SRS parameter.

### CROSS-REFERENCE TO RELATED APPLICATIONS

This application claims the benefit of U.S. Provisional Application No. 63/334,994, filed Apr. 26, 2022 and U.S. Provisional Application No. 63/422,666, filed Nov. 4, 2022, the contents of which are incorporated herein by reference.

### BACKGROUND

5G New Radio (NR) supports reciprocity-based channel estimation and precoding in time division duplex (TDD) scenarios with sounding reference signal (SRS) resources usage set to antennaSwitching. An uplink (UL) channel may be estimated at a gNB when a wireless transmit/receive unit (WTRU) sends an SRS and the same channel may be assumed for the downlink (DL) since UL and DL may be sent on a same carrier frequency. The gNB may use the UL channel to determine downlink precoders.

### SUMMARY

A method and a wireless transmit/receive unit (WTRU) for multiple transmission and reception point (mTRP) transmission may comprise a WTRU configured to receive configuration information indicating a sounding reference signal (SRS) resource set that includes at least one or more SRS resources, one or more SRS parameters, and one or more time-based patterns. The WTRU may be configured to receive an indication to activate a time-based pattern of the one or more time-based patterns. The WTRU may be configured to transmit a first SRS in a first time instance using a first SRS resource of the one or more SRS resources and a first SRS parameter of the one or more SRS parameters. The first SRS resource and the first SRS parameter may be determined based on the activated time-based pattern. The WTRU may be configured to transmit a second SRS in a second time instance that is different than the first time instance using the first SRS resource and a second SRS parameter. The second SRS parameter may be determined based on the activated time-based pattern. The configuration information may further indicate a plurality of pathloss reference signals (PL RS). The configuration information may further indicate an association between each SRS resource and a respective subset of the plurality of PL RS. The first SRS may be transmitted with a transmit power determined based on a PL RS of the plurality of PL RS. The PL RS may be determined based on the activated time-based pattern. The second SRS may be transmitted with a transmit power determined based on a PL RS of the plurality of PL RS. The PL RS may be determined based on the activated time-based pattern. The first SRS parameter and the second SRS parameter may be a respective first and second cyclic shift (CS) and the first and second CS may be different. The indication to activate a time-based pattern may be received in downlink control information (DCI) or a medium access control (MAC) control element (CE). The WTRU may be configured to determine a time-based pattern to activate based on the indication to activate a time-based pattern. The one or more SRS parameters may comprise a cyclic shift, a comb, a time offset, a sequence index, or a group index. The first SRS parameter may be based on the activated time-based pattern and the first time instance and the second SRS parameter may be based on the activated time-based pattern and the second time instance

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example of an SRS transmission in mTRP;

FIG. 3 is an example of method of dynamic joint SRS configuration and offset triggering;

FIG. 4 shows an example SRS offset codepoint indicator association;

FIG. 5 shows an example offset to SRS configurations association;

FIG. 6 shows an example method of mTRP SRS transmission;

FIG. 7 shows an example method of mTRP SRS transmission;

FIG. 8 shows an example method of mTRP SRS transmission;

FIG. 9 shows an example time-based patterns; and

FIG. 10 shows an example mTRP SRS transmission based on activated patterns.

### DETAILED DESCRIPTION

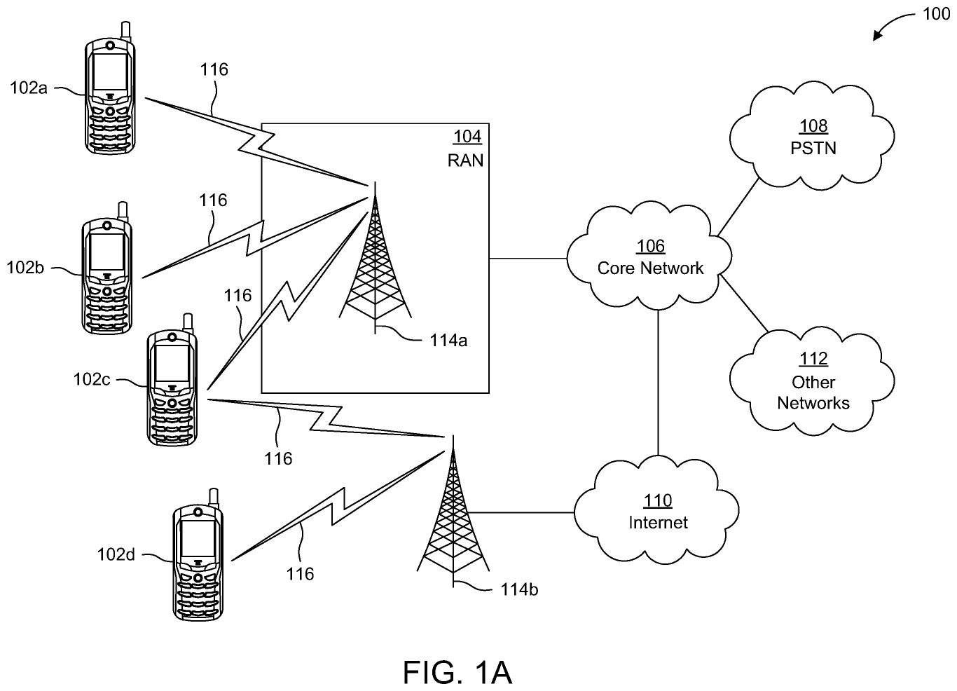

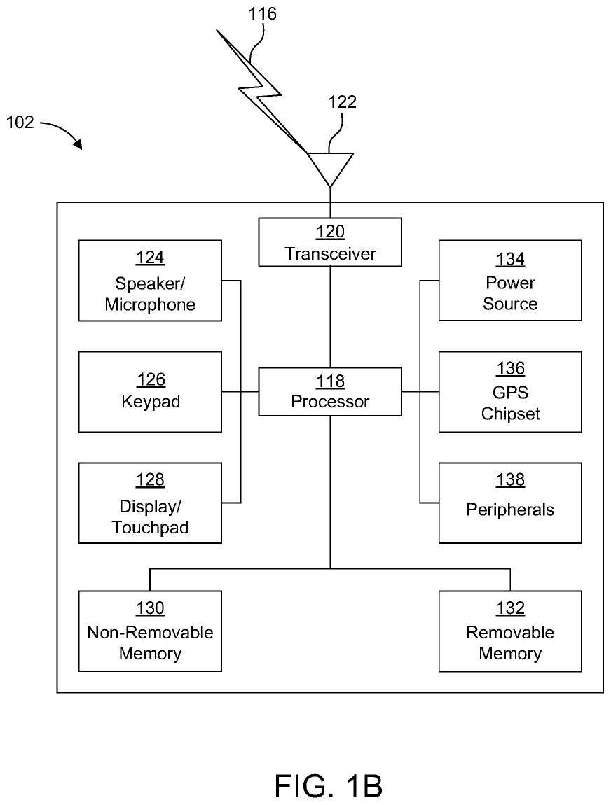

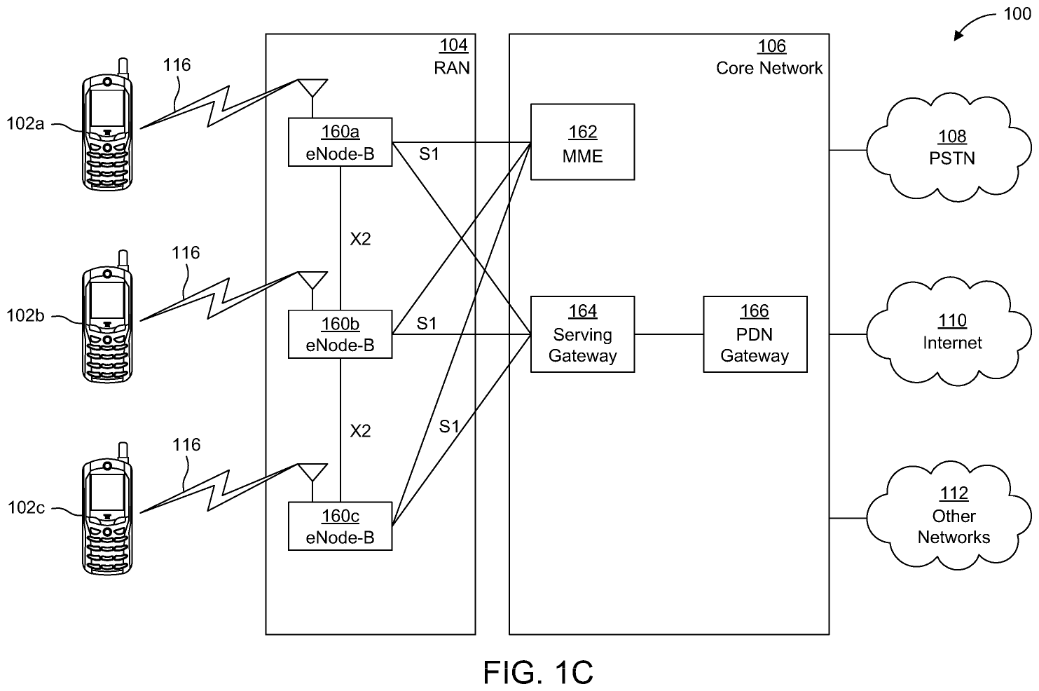

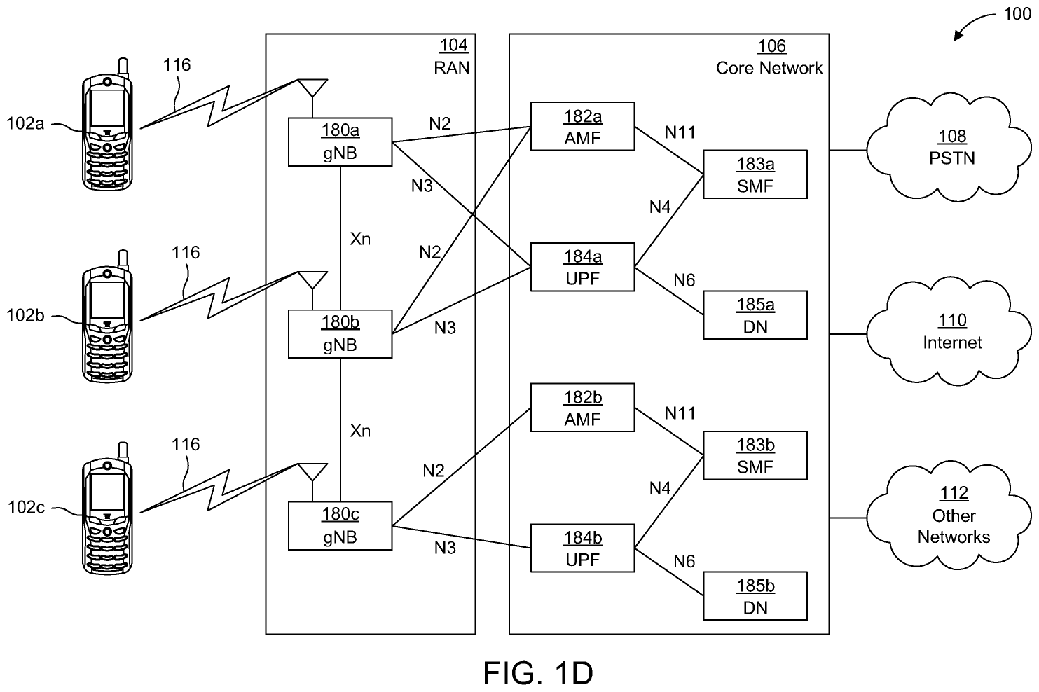

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

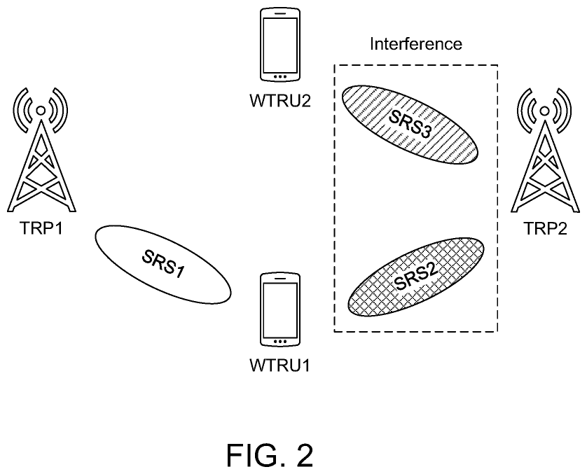

3GPP Rel-18 Multiple Input Multiple Output (MIMO) aims to improve channel state information (CSI) acquisition for TDD Coherent-Joint Transmission (C-JT) through enhancements to the sounding reference signal (SRS), as discussed in 3GPP RP-213598. Study, and if justified, specify enhancements of CSI acquisition for Coherent-JT targeting FR1 and up to 4 transmission/reception points (TRPs), assuming ideal backhaul and synchronization as well as the same number of antenna ports across TRPs, as follows: SRS enhancement to manage inter-TRP cross-SRS interference targeting TDD C-JT via SRS capacity enhancement and/or interference randomization, with the constraints that 1) without consuming additional resources for SRS; 2) reuse existing SRS comb structure; and 3) without new SRS root sequences. FIG. 2 shows an example of SRS transmissions in multiple TRP (mTRP).

For SRS configuration in 3GPP Rel-17: only one spatial filter is associated per SRS resource; only one set of power control parameters is active at a time for an SRS resource; and for aperiodic SRS (A-SRS), a downlink control information (DCI) may indicate a 2 bit codepoint: trigger no SRS resource sets, or trigger resource sets with codepoint 1, 2, or 3. The codepoint is configured as part of the SRS resource set with aperiodicSRS-resourceTrigger, and aperiodicSRS-resourceTriggerList values.

The 3GPP Rel-17 SRS resource configuration may flexibly allocate resources orthogonally or with low cross-correlation by shifting time/frequency locations of transmissions and with different sequences/orthogonal cover codes (OCCs). However, resource sets are configured per TRP without considering configurations of other TRPs. In mTRP, a WTRU may transmit SRS towards more than one TRP to estimate multiple channels which may cause more congestion. This may cause high interference between SRS resources transmitted from different WTRUs.

The following issues need to be considered: how a WTRU determines multi-TRP SRS resource configurations to reduce inter-TRP interference; and how does a WTRU determine which combination of SRS resources to transmit for C-JT multi-TRP precoder measurement.

Hereinafter, ‘a’ and ‘an’ and similar phrases may be interpreted as ‘one or more’ and ‘at least one’. Similarly, any term which ends with the suffix ‘(s)’ may be interpreted as ‘one or more’ and ‘at least one’. The term ‘may’ may be interpreted as ‘may, for example’.

A WTRU may transmit or receive information over a physical channel or transmit or receive a reference signal (RS) according to at least one spatial domain filter. The term “beam” may be used to refer to a spatial domain filter.

A WTRU may transmit information over a physical channel or transmit or receive a signal using the same spatial domain filter as the spatial domain filter used for receiving a RS (e.g. CSI-RS) or a synchronization signal (SS) block. The WTRU transmission may be referred to as “target” and the received RS or SS block may be referred to as “reference” or “source”. In such a case, the WTRU may be said to transmit information over the target physical channel or transmit the signal according to a spatial relation with a reference to such a RS or SS block.

The WTRU may transmit information over a first physical channel or transmit a signal according to the same spatial domain filter as the spatial domain filter used for transmitting information over a second physical channel or transmitting a signal. The first and second transmissions may be referred to as “target” and “reference” (or “source”), respectively. In such a case, the WTRU may be said to transmit information over the first (target) physical channel or transmit the signal according to a spatial relation with a reference to the second (reference) physical channel transmission n or signal.

A spatial relation may be implicit, configured, for example by RRC signaling, or signaled, for example by a medium access control (MAC) control element (CE) or DCI. For example, a WTRU may implicitly transmit over a PUSCH and demodulation reference signal (DM-RS) of the PUSCH according to the same spatial domain filter as an SRS indicated by an SRS resource indicator (SRI) indicated in a DCI or configured by RRC signaling. In an example, a spatial relation may be configured by RRC for an SRI or signaled by a MAC CE for a PUCCH. Such spatial relation may also be referred to as a “beam indication”.

The WTRU may receive a first (target) downlink channel transmission or signal according to the same spatial domain filter or spatial reception parameter as a second (reference) downlink channel transmission or signal. For example, such association may exist between a physical channel such as a PDCCH or a PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may receiver an indication of an association between a CSI-RS or SS block and a DM-RS by an index to a set of TCI states configured by RRC signaling and/or signaled by a MAC CE. Such indication may also be referred to as a “beam indication”.

Hereafter, RS may be interchangeably used with one or more of: RS resource, RS resource set, RS port and RS port group, and still consistent with this disclosure.

Hereafter, RS may be interchangeably used with one or more of: SSB, CSI-RS, SRS and DM-RS, and still consistent with this disclosure.

Hereafter, a TRP (e.g., transmission and reception point) may be interchangeably used with one or more of: TP (transmission point), RP (reception point), RRH (radio remote head), DA (distributed antenna), BS (base station), a sector (of a BS), and a cell (e.g., a geographical cell area served by a BS), and still consistent with this disclosure. Hereafter, multi-TRP may be interchangeably used with one or more of: mTRP, m-TRP, and multiple TRPs, and still consistent with this disclosure.

A WTRU may be configured with, or may receive a configuration of, one or more TRPs to which the WTRU may transmit and/or from which the WTRU may receive. The WTRU may be configured with one or more TRPs for one or more cells. A cell may be a serving cell or a secondary cell.

A WTRU may be configured with at least one RS for a purpose of channel measurement. This RS may be denoted as a Channel Measurement Resource (CMR) and may comprise a CSI-RS, SSB, or other downlink RS transmitted from the TRP to the WTRU. A CMR may be configured or associated with a TCI state. A WTRU may be configured with a CMR group which may comprise CMR indices transmitted from the same TRP. Each group may be identified by a CMR group index (e.g. group 1). A WTRU may be configured with one CMR group per TRP, and the WTRU may receive a linkage between one CMR group index and another CMR group index, or between one RS index from one CMR group and another RS index from another group. A WTRU may determine that linked resources may be configured for C-JT.

A WTRU may be configured with, or receive configuration of, one or more pathloss (PL) reference groups (e.g., sets) and/or one or more SRS groups, SRS resource indicator (SRI), or SRS resource sets.

A PL reference group may correspond to or may be associated with a TRP. A PL reference group may include, identify, correspond to, or be associated with one or more TCI states, SRIs, reference signal sets (e.g. CSI-RS set, SRI sets), CORESET index, and/or reference signals (e.g. CSI-RS, SSB).

A WTRU may receive a configuration (e.g., any configuration described herein). The configuration may be received from a gNB or TRP. For example, the WTRU may receive configuration of one or more TRPs, one or more PL reference groups and/or one or more SRI sets. The WTRU may implicitly determine an association between a RS set/group and a TRP. For example, if the WTRU is configured with two SRS resource sets, then the WTRU may determine to transmit to TRP1 with a SRS in the first resource set, and to TRP2 with a SRS in the second resource set. The configuration may be via RRC signaling, a MAC CE, or a DCI.

A WTRU may receive an indication of a primary and a secondary TRP. When a WTRU is configured with multiple TRPs, it may determine that one of the TRP is a primary or anchor TRP. This designation may be based on a network configuration, or WTRU determination (e.g. received signal quality for one TRP is above all other TRP's received signal quality, or above a threshold).

In the examples and embodiments described herein, TRP, PL reference group, SRI group, and SRI set may be used interchangeably. The terms set and group may be used interchangeably herein.

Hereafter, for the brevity of discussion, a coherent joint transmission system with two TRP is considered, however the proposed solutions and processes may equally be used for cases with more than two TRP. In an exemplary embodiment, one of the TRP may be considered as the primary TRP.

A property of a grant or assignment may comprise of at least one of the following: a frequency allocation; an aspect of time allocation, such as a duration; a priority; a modulation and coding scheme; a transport block size; a number of spatial layers; a number of transport blocks; a TCI state, CRI or SRI, wherein a TCI state, CRI, or SRI may be for each WTRU's panel if multiple panels are used for an UL transmission; a number of repetitions; a repetition scheme type (e.g. Type A or Type B); whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); any parameter provided in a DCI, by MAC, or by RRC for the scheduling grant or assignment; whether the grant is for single-TRP transmission or multi-TRP transmission; whether the grant is for UL transmission from a single WTRU panel (TxSP) or simultaneous UL transmission from multiple WTRU panels (STxMP); or whether the grant is for a C-JT or non-coherent joint transmission (NC-JT) transmission.

A WTRU may report a subset of channel state information (CSI) components. The CSI components may correspond to at least a CSI-RS resource indicator (CRI), a SSB resource indicator (SSBRI), an indication of a panel used for reception at the WTRU (such as a panel identity or group identity), measurements such as L1-reference signal receive power (RSRP), L1-SINR taken from SSB or CSI-RS (e.g. cri-RSRP, cri-SINR, ssb-Index-RSRP, ssb-Index-SINR), and other channel state information such as at least a rank indicator (RI), a channel quality indicator (CQI), a precoding matrix indicator (PMI), Layer Index (LI), and the like.

A WTRU may receive SRS configurations which may indicate SRS resource sets comprising one or more SRS resources. SRS resources may be configured with time and frequency domain locations that may span over one or more symbols and one or more RBs.

Hopping may be used such that an SRS resource may be transmitted in a preconfigured pattern of RBs over time, and repetitions may be used to repeat a SRS over multiple symbols.

The granularity in the frequency domain may be changed using a comb structure to multiplex multiple SRS resources orthogonally in the frequency domain. For example, a comb of 2 may mean that an SRS is transmitted every 2^{nd} RE (e.g. only odd or only even), and a starting offset may be configured with respect to the PRB boundary such that a WTRU may determine which set of REs to use. For example, with a comb of 4, a WTRU may transmit on every 4th RE, and 4 possible offsets (e.g. 0, 1, 2, 3) may be configured as a starting point of the comb.

An RB Partial Frequency Sounding (RPFS) may be configured such that a WTRU may transmit a SRS in a fraction of the bandwidth. The fraction may be given by the RPFS (e.g. ½, ¼). For example, an RPFS of ½ may mean a WTRU may transmit SRS in either even RBs or odd RBs. An RB offset may be configured to determine the starting point of the RPFS.

A WTRU may generate a SRS using a base sequence that may be mapped to the OFDM symbols of a SRS resource based on a configured time/frequency mapping. A WTRU may receive a cyclic shift (CS) which determines a phase rotation applied to the base sequence. Different cyclic shifts of a same base sequence generate SRSs that are orthogonal to each other. For example, for one WTRU with more than one antenna port, one base sequence may be used and each port may use a different cyclic shift.

Base sequences may be grouped depending on the sequence length into 30 groups with a group index each, and at most two sequences may be configured per group with a sequence index either 0 or 1. A WTRU may be configured with group or sequence hopping, where a group or sequence index is pseudorandomly selected for every OFDM symbol and slot of the SRS resource.

A C-JT deployment may comprise multiple points of transmission with their corresponding channels. In such a scenario, the acquired CSI should reflect accurate information about the state of each link with minimum skew between measurements of the participating links. Reference signal transmissions related to CSI measurements should occur with minimum interference. More than one WTRU may be served by a set of TRPs. Each WTRU may receive an SRS configuration which may be transmitted periodically or semi-statically activated. The network may receive the SRS for UL channel estimation from more than one WTRU at the same time. This may result in high interference between SRSs transmitted towards different TRPs. For example, a first WTRU (e.g. WTRU1) may transmit a first SRS (e.g. SRS1) to a first TRP (e.g. TRP1), and a second WTRU (e.g. WTRU2) may transmit a second SRS (e.g. SRS2) to a second TRP (e.g. TRP2). If both SRS are transmitted at the same time, SRS1 transmission may interfere with SRS2 transmission at TRP2's receiver. Furthermore, the signaling associated to the configuration and triggering of an SRS transmission should not significantly exceed of a single TRP transmission.

A WTRU may determine the SRS transmission parameters as a function of the set of TRPs and activated TRPs.

In an embodiment, a WTRU may receive configuration parameters M and N that represent the overall number of potential transmissions points and the number of transmission points activated for a scheduled joint transmission, respectively.

In an embodiment, a WTRU may receive a set of information that may comprise two parts of TRP-common and TRP-specific information. The TRP-common information may comprise some basic transmission parameters that may be common across all the TRPs (e.g., gNB antenna configuration, number of transmission ports, etc.). A WTRU may receive TRP-common information through a semi-static or dynamic configuration (e.g., RRC signaling or a MAC CE).

In an embodiment, a WTRU may receive a TRP-specific configuration of N1≥N TRPs by RRC signaling or a dynamic indication (e.g., a MAC CE). The WTRU may receive another dynamic indication (e.g., a DCI) to initiate a transmission or reception process associated to the N of N1 TRPs.

A WTRU may receive multiple SRS resource set configurations. Each configuration may be TRP specific.

In an embodiment, a WTRU may receive a set of SRS configurations corresponding to SRS transmissions to multiple TRPs. In an embodiment, a WTRU may receive a configuration of SRS resource groups where each resource group is configured per TRP. For example, SRS resource group 1 may be configured with one or more SRS resource sets, and a SRS resource group 2 may be configured with one or more SRS resource sets. Each resource group may be associated to a TRP. A WTRU may receive a pairing for C-JT between SRS resource sets through RRC configuration or a MAC-CE.

In an embodiment, a WTRU may use some of the configuration parameters universally for all TRPs, for example, configured as a TRP-common information. For example, a WTRU may receive a fixed comb value and/or number of SRS ports for SRS transmission associated to all TRPs. The configuration of TRP-common SRS parameters may be through an RRC configuration and/or a MAC CE.

In an embodiment, a WTRU may receive SRS configurations corresponding to each of N1 TRPs, for example, TRP-specific. In an embodiment, a WTRU may receive N1 set of TRP-specific configurations by an RRC configuration or a MAC CE indication. Such information may comprise, for example, a reference signal indication used for spatial beam, reference signal indication for pathloss computation, or cyclic shift, hopping information.

In an embodiment, a WTRU may receive an implicit or an explicit indication to initiate an SRS transmission. The received indication may also indicate the N selected TRPs from the set of N1 for SRS transmission.

In an embodiment, a WTRU may receive a configuration to define the valid time resources (e.g., slots, symbols, etc.) for transmission of each SRS resource. A WTRU may receive at least one set of time resource definitions for each TRP link. In an embodiment, if a WTRU is configured with more than one set of time resources for a TRP, the WTRU may receive an indication for selection of the time resource in a received command to trigger the SRS transmission (e.g., in a DCI field).

In an embodiment, a WTRU may receive a configuration that may comprise more than one set of TRP-specific configurations per TRP. A WTRU may receive an indication of a usage pattern for the configured TRP-specific configuration (e.g., a table associating a TRP-specific configuration with different time resources). A WTRU may receive an indication to randomly select one of the configured sets for SRS transmission to a TRP. In an embodiment, a WTRU may use a pseudo random procedure that may also be known for the gNB to select SRS transmission parameters to each TRP. The pseudo random selection procedure may be defined based on one or more than one parameter (e.g., cell index, cell-radio network temporary identifier (C-RNTI), etc.).

A WTRU may receive one SRS resource set configuration which may comprise more than one TRP-specific SRS resources.

In an embodiment, a WTRU may receive a configuration for SRS resource set transmission to multiple TRPs. One or more of the followings may be used for configuration and transmission of SRS to multiple TRPs.

A WTRU may be configured with more than one SRS resource. Each SRS resource may be associated for SRS transmission to at least one TRP. In an embodiment, some parameters of the SRS resource may be common across all the configured SRS resources, while some other parameters may vary according to the associated TRP link. For example, all configured SRS resources may have a same bandwidth but they may be configured with different cyclic shift, or other parameters.

A WTRU may transmit an SRS to each TRP by using at least one spatial filter configuration. In an embodiment, a WTRU may use a same beam for transmission to all TRPs. In an embodiment, a WTRU with two transmission links may be configured with K SRS transmission events per link (e.g., TRP link). The K transmission events to TRP links may be configured to be sequential or interleaved.

In an embodiment, a WTRU may be indicated dynamically or semi-statically the link corresponding to the first SRS transmission. For example, a WTRU may receive an implicit or explicit indication in the dynamic indication that triggers the SRS transmission (e.g., a DCI). A WTRU may begin the SRS transmission from a pre-determined link (e.g., the link indicated associated with a primary TRP, configured by gNB, etc.).

A WTRU may transmit an SRS to each TRP by using at least one of the following modes for setting the transmission power.

A WTRU may transmit SRS to all the configured transmission points using an equal power. In this mode, a WTRU may be configured with a single reference signal as the reference for pathloss estimation. In an embodiment, a WTRU may or may not use a same beam for each SRS transmission event. For example, in an embodiment, a WTRU may receive a single reference signal as the uplink beam indication for transmission to all TRPs. In an embodiment, a WTRU may receive more than one reference signal as the uplink beam indication for multiple transmissions where each transmission may be based on a different reference signal.

A WTRU may transmit an SRS to each of configured transmission points using a different power. In this mode, a WTRU may be configured with multiple reference signals where each may be used as the reference for pathloss estimation of a different TRP link. In an embodiment, a WTRU may or may not use a same beam for each SRS transmission event. For example, a WTRU may receive a single reference signal as the uplink beam indication for transmission to all TRPs.

In an embodiment, a WTRU may receive more than one reference signal as the uplink beam indication for multiple transmissions where each transmission may be based on a different reference signal.

A WTRU may determine transmission opportunities of SRS resources based on a pattern of active symbols or slots.

In an embodiment, a WTRU may receive a skipping pattern of time indices where SRS transmission may be omitted, and an index of the target TRP per slot. In the following, the use of slot may be interchangeably used with per symbol or per RB. The pattern may reduce interference at the target TRP since a WTRU may skip transmissions that may occur in the indicated slot. For example, a WTRU may receive a pattern indicating ({slot 1, TRP1}, {slot 2, TRP2}). The WTRU may determine to send SRS resources in slot 1 for any TRP except TRP1, and likewise send SRS resources in slot2 for any TRP except TRP2. This may result in less interference by the WTRU at TRP1 in slot 1, and less interference at TRP2 in slot 2.

The pattern may be configured to avoid interference from all WTRUs served by one TRP. A group of WTRUs may receive the indication through a group-common DCI with, for example, a group specific RNTI. For example, the pattern may be configured such that a WTRU in group 1 served by TRP1 may only transmit SRS in slot 2, and not slot 1. A WTRU in group 2 served by TRP2 may transmit SRS in slot 1 to TRP1 and TRP2 for a measurement hypothesis without interference from a WTRU served by TRP1. The network may receive the SRS and determine the C-JT precoders for WTRUs in group 2 using TRP1 and TRP2.

More than one TRP may be configured in the pattern such that slot 1 is TRP1, slot 2 is TRP2, and so on.

A pair of TRPs (e.g. TRP1 and TRP2) may be indicated in one skipping slot such that a WTRU may omit any SRS transmission to either TRP1 or TRP2.

The pattern may be WTRU-specifically indicated to limit interference from a WTRU. For example, WTRU1 and WTRU2 may be served by TRP1, and WTRU1 may receive a skipping indication. WTRU1 may only transmit in slots other than the indicated skipping pattern. WTRU2 may transmit SRS without interference from WTRU1.

A WTRU may determine from the pattern the next valid uplink subframe for SRS transmission. For example, the WTRU may receive a pattern indicating to skip the next X slots. The WTRU may transmit an SRS X slots after receiving the indication. During the X slots, the WTRU may omit transmission.

A WTRU may receive the skipping pattern dynamically. For example, a field in a grant (e.g. DCI, configured grant (CG)) may indicate one out of a set of preconfigured patterns. The pattern may be indicated similarly to a Slot Format Indicator (SFI) with one or more skipped slots, and one or more TRPs per skipped slot. One skipping pattern may be linked to one or more of the SFI patterns such that skipped slots are mapped to DL, UL, or flexible (F) subframes that may be used as either DL or UL. For example, SFI pattern 1 may be all uplink slots. The first two UL occasions may be linked to TRP1, and the next two UL occasions may be linked to TRP2. A WTRU may transmit an SRS to TRP1 only in the first two UL occasions (i.e., omit SRS to TRP2), and only to TRP2 in the next two UL occasions (i.e., omit SRS to TRP1).

More than one set of patterns may be configured as part of the SRS resource set configuration, and one out of the set may be dynamically activated through a command or grant (e.g. a DCI or a MAC-CE). The pattern may also be configured separately from the SRS configuration, and the WTRU may apply the pattern to any UL transmission (e.g. PUCCH, PUSCH, CG). The WTRU may apply the pattern periodically according to a configured period. For example, a pattern of X slots may be repeated every Y slots. The WTRU may apply the pattern semi-persistently (SP). For example, the pattern may be activated after a configurable threshold with respect to a DCI, and remain active for the next Z slots. After the active period, the WTRU may resume transmission of SRS as configured without skipping slots. A WTRU may receive a command (e.g. a MAC-CE) activating/deactivating a SP pattern.

A WTRU may determine the skipping rule implicitly based on the target TRP per SRS. For example, a rule may be defined where TRP1 may have higher priority than TRP2. A WTRU may determine to transmit the SRS for TRP1 and omit the SRS for TRP2 if both SRS are configured/triggered to be sent on the same slot.

A WTRU may select SRS parameters per TRP based on activated TRPs.

In an embodiment, a WTRU may determine that an SRS resource set or SRS resource may include an index to a CMR group (e.g. group of CSI-RS for downlink channel measurement). The WTRU may determine that a SRS resource set or SRS resource is associated to a TRP through the CMR group association. For example, CMR group 1 may be associated to TRP1 and CMR group 2 may be associated to TRP2. A WTRU may be configured with more than one set of parameters and based on the association to a CMR group, the WTRU may select the parameters for the SRS transmission towards the target TRP. A WTRU may receive an activation command through, for example, a grant or MAC-CE. The WTRU may determine which CMR group is activated (i.e. TRP) for the SRS resource.

For example, an SRS resource set may be configured with one set of parameters for CMR group 1 and another set of parameters for CMR group 2. If CMR group 1 is active, a WTRU may select the parameters for the SRS associated to CMR group 1. If CMR group 2 is active, a WTRU may select the parameters for the SRS associated to CMR group 2. These parameters may include one or more of: cyclic shift (CS); comb; time offset; RPFS; frequency offset; base sequence index; sequence group index; or hopping.

In an example, a WTRU may send an SRS sequence with group hopping turned on, where group 1 may be associated to CMR group 1 and group 2 may be associated to CMR group 2. Similarly, with sequence hopping, a WTRU may select one sequence when transmitting to TRP1 and a second sequence when transmitting to TRP2.

A WTRU may receive a pairing of active CMR groups that may correspond to TRPs coordinating for C-JT. A WTRU may select the parameters as a function of the pairing of CMRs. For example, a WTRU served by TRP1 and TRP2 may determine to use a same base sequence for both TRPs, and the WTRU may use different CSs for each TRP. If different CMR groups are paired, the WTRU may select a different base sequence.

In an example, a WTRU may select a different parameter as a function of the TRP pair configured for C-JT. For example, two CMR groups may be configured with an SRS resource for TRP1 and TPR2, and a comb of 2. There may be two possible offsets for the comb: starting at RE1 or at RE2. A third TRP may be paired with either TRP1 or TRP2 such that a WTRU may be in C-JT with either TRP1 and TRP3, or TRP2 and TRP3. Depending on which TRP is paired with TPR3, a WTRU may select different offsets for the SRS resource. If the SRS resource is transmitted to TRP1, a WTRU may select offset 1 starting at RE1, and if the SRS is transmitted to TRP2 a WTRU may select offset 2 starting at RE2.

Similarly, with the RPFS, a WTRU may select offset 1 starting at RB1 for TRP1, and select offset 2 starting at RB2 for TRP2. Similarly, time offsets may be selected per TRP (e.g. OFDM symbol offset 1 for TRP1, and OFDM symbol offset 2 for TRP2).

In an embodiment, a WTRU may receive a time bundling configuration across multiple slots, and each slot may be associated to one CMR group (i.e., TRP). For example, a WTRU may receive a time bundling of two slots, and CMR group 1 associated to slot 1, and CMR group 2 associated to slot 2. The WTRU may determine to use one of the parameters (e.g. sequence index 1) in slot 1, and a second parameter (e.g. sequence index 2) in the slot 2. The WTRU may send an SRS on each slot in the bundle towards the target TRP with the WTRU selected parameter per slot.

In an embodiment, a WTRU may receive one or more configuration parameters comprising configuration of a first SRS resource (targeted to a first TRP) and configuration of a second SRS resource (targeted to a second TRP), where the WTRU may receive an indication (e.g., based on the configuration of the second SRS resource or based on the one or more configuration parameters) that the second SRS resource is associated with the first SRS resource, for example in terms of mTRP operation (e.g., for mTRP channel acquisition/estimation, etc. and/or in terms of an aperiodic SRS triggering mechanism.

In an example, the WTRU may receive configuration of a plurality of aperiodic SRS triggering states (e.g., aperiodicSRS-resourceTriggerList or aperiodicSRS-resourceTrigger), for example by RRC signaling, where one or more SRS triggering states of the plurality of aperiodic SRS triggering states may be indicated/selected (e.g., activated by a MAC-CE) to be mapped to one or more codepoints of a field (e.g., an SRS request field) of a DCI. The WTRU may receive an indication (e.g., configuration) that a first SRS triggering state of the plurality of aperiodic SRS triggering states comprises the first SRS resource (targeted to a first TRP), but does not (explicitly) comprise the second SRS resource.

Based on determining that the first SRS resource is comprised in the first SRS triggering state and the first SRS resource has an association with the second SRS resource (e.g. in terms of the mTRP operation and/or the aperiodic SRS triggering procedure), the WTRU may determine that a codepoint, of the one or more codepoints, indicating the first SRS resource may indicate both the first SRS resource and the (associated) second SRS resource to be transmitted by the WTRU.

In an example, the indication by the codepoint triggering transmissions of both the first SRS resource and the second SRS resource may be based on a (explicit) parameter value (e.g., one bit parameter to toggle mTRP parameters or preconfigured patterns/parameters) in the DCI (e.g., indicating an mTRP mode, multiple SRS transmissions for mTRP operation, etc.), or based on an implicit indication associated to a value of an existing field in the DCI. In an example, based on determining that the (explicit) parameter value or the implicit indication indicates otherwise, the WTRU may transmit only the first SRS resource in response to receiving the DCI. This may reduce signaling overhead in the aperiodic SRS triggering procedure and improve flexibility and efficiency in managing multiple aperiodic SRS resources to be triggered for mTRP channel acquisition/estimation.

At least one of following (e.g., based on an indication/configuration from the gNB and/or based on a pre-defined/pre-determined rule) may apply, where the at least one of the following may be based on, or in relation to, the transmissions of both the first SRS resource and the (associated) second SRS resource (for mTRP channel acquisition).

The WTRU may receive multiple (SRS-related) parameters associated with an SRS resource set comprising one or more SRS resources (e.g., at least the first SRS resource and the second SRS resource), where the multiple parameters may comprise N time-domain offsets (e.g., one offset per TRP). The one offset per TRP may be applied as being relative to a SRS-triggering DCI (e.g., a time instance of receiving the SRS-triggering DCI).

The WTRU may receive a DCI comprising an SRS-request field, where a codepoint of the SRS-request field may indicate the first SRS triggering state comprising at least the first SRS resource (being comprised in the SRS resource set). In response to receiving the DCI, the WTRU may transmit the first SRS resource based on a first offset, associated with the first TRP, of the N time-domain offsets and transmit the second SRS resource (e.g., being associated with the first SRS resource) based on a second offset, associated with the second TRP, of the N time-domain offsets.

The WTRU may receive, for example by RRC signaling, multiple combinations of SRS-related parameters (e.g., cyclic shift, comb value, sequence related parameter such as sequence ID or group ID, port configuration, SRS power control parameter including a pathloss RS, etc.) for the first SRS resource and/or the second SRS resource. The WTRU may receive, for example by a MAC-CE, a subset of the multiple combinations for the first SRS resource and/or the second SRS resource. The WTRU may receive, for example by a DCI, a dynamic trigger of one or more of the multiple, or the subset of the multiple, combinations of SRS-related parameters for the first SRS resource and/or the second SRS resource (e.g., based on the codepoint indicated by the DCI).

In an example, the DCI triggering transmission of at least one SRS resource may update SRS-related parameters (e.g., cyclic shift, comb value, sequence related parameter such as sequence ID or group ID, port configuration, SRS power control parameter, etc.) of an SRS resource being triggered by the DCI, which may reduce control signaling overhead and latency as the DCI may update/change SRS-related parameters of the SRS resource (e.g., instead of updating the parameters via RRC reconfiguration).

In an example, the WTRU may expect (e.g., a gNB shall ensure) that the DCI triggering transmission of the at least one SRS resource does not comprise a data scheduling assignment/grant (e.g., as an SRS-triggering DCI without data scheduling). This may provide benefits in terms of reducing the control signaling overhead and latency based on more bitfields being available in the DCI (without data), for example, to indicate the combinations.

In an example, a different RNTI value (e.g., RNTI associated to an SRS configuration) may be used for reception of the DCI.

In an example, a MAC-CE command may update SRS-related parameters (e.g., cyclic shift, comb value, sequence related parameter such as sequence ID or group ID, port configuration, SRS power control parameter, etc.) of an SRS resource, which may reduce control signaling overhead and latency as the MAC-CE may update/change SRS-related parameters of the SRS resource (e.g., instead of updating the parameters via RRC reconfiguration).

The WTRU may only expect that, for an SRS resource (e.g., the first SRS resource or the second SRS resource), the same comb value is indicated by the dynamic trigger, which may reduce an uplink interference based on avoiding/reducing frequency-domain resource (e.g., RE) collisions. In an example, the WTRU may expect (e.g., a gNB shall ensure) that a parameter for comb may not be comprised in the multiple combinations of the SRS-related parameters.

In an embodiment, a WTRU may transmit an SRS with a parameter set associated to a TRP or to a TRP group (e.g. TRP1 and TRP2) as a function of an aperiodic (A-SRS) triggering point (i.e. SRS request field). For example, a WTRU may receive a configuration of an SRS resource set with one SRS resource, and the SRS resource may be configured with a plurality of parameter sets. A parameter set may comprise a set of parameters such as, for example, power control parameters (e.g. pathloss reference signal (PL-RS), alpha, P0), spatial filter (e.g. SRIs), CS index, comb offset, hopping pattern, frequency/time offset, or sequence/group index. One parameter set may be active at the time of WTRU transmission of the SRS. To determine which parameter set is active, the WTRU may receive an A-SRS configuration of codepoints where each codepoint may map to one of the parameter sets. For example, codepoint 1 may map to CS index 1, and codepoint 2 may map to CS index 2. The WTRU may receive a scheduling grant (e.g. DCI) which may include an SRS request field codepoint, and the WTRU may activate the parameter set associated to the codepoint to transmit the SRS resource.

A WTRU may determine a TRP specific parameter set to activate for A-SRS transmission as a function of an SRS resource set indicator field and an SRS request field. For dynamic switching between single TRP (STRP) and multiple TRP (mTRP) repetition scheduling, a grant may comprise a 2 bit field where, for example, 00 may indicate sTRP1, 01 may indicate sTRP2, and 10 and 11 may indicate mTRP with a repetition ordering of TRP1-TRP2 or TRP2-TRP1, respectively. If an A-SRS resource is triggered, and the SRS resource set indicator indicates sTRP1, the WTRU may transmit an SRS with a first parameter set activated (e.g. associated to TRP1's PL-RS). If the SRS resource set indicator indicates sTRP2, the WTRU may transmit an SRS with a second parameter set activated (e.g. associated to TRP2's PL-RS). If the SRS resource set indicator indicates TRP1-TRP2 or TRP2-TRP1, the WTRU may transmit an SRS with a parameter set configured for mTRP operation (e.g. C-JT). For example, a WTRU may be triggered to transmit an SRS with multiple parameter sets, where a first slot may use a parameter set for TRP1, and a second slot may use a parameter set for TRP2. The SRS resource set indicator may be expanded with additional bits to enable the triggering of multiple combinations of TRPs (e.g. TRP1-TRP2-TRP3, TRP1-TRP3, etc.). The TRP index associated with the SRS resource set indicator may be reconfigured through, for example, RRC signaling or a MAC-CE. For example, the indicator may be associated to TRP1/TRP2/TRP1-TRP2/TRP2-TRP1, or may be reconfigured to be associated with TRP1/TRP3/TRP2/TRP1-TRP3.

A WTRU may determine a time slot of an A-SRS based on an RRC configured value of a number of slots (n) after a triggering DCI is received. The WTRU receives n as part of the SRS resource set configuration. A WTRU may receive an SRS offset indicator bit field in a grant, which may dynamically indicate an additional offset (e.g. k slots) from the triggering DCI to the SRS transmission. A list of up to four offsets (e.g. k1, k2, k3, k4) may be RRC configured, and the DCI may dynamically indicate one of the values from the list (e.g. k=k1). The WTRU may transmit the SRS in the (n+k)-th slot after the DCI.

For mTRP, it may be desirable for the network to trigger more than one SRS resource with different parameter configurations to target different TRPs. A WTRU may send multiple SRSs to enable the multiple TRPs to estimate the different WTRU-TRP channels. Triggering multiple SRS with different dynamic offsets and configurations requires multiple DCIs with different indicated dynamic offsets. This may generate high PDCCH resource overhead since multiple DCIs are used for one WTRU to trigger multiple SRSs.

In an embodiment, a WTRU may receive an SRS offset indicator codepoint bit field where each codepoint may map to or be associated with one or more SRS offset values, and each offset codepoint or value may be associated with an SRS parameter set. A WTRU may be triggered to transmit the same SRS resource at multiple time offsets with one parameter set activated per time offset. A single triggering command may be sufficient.

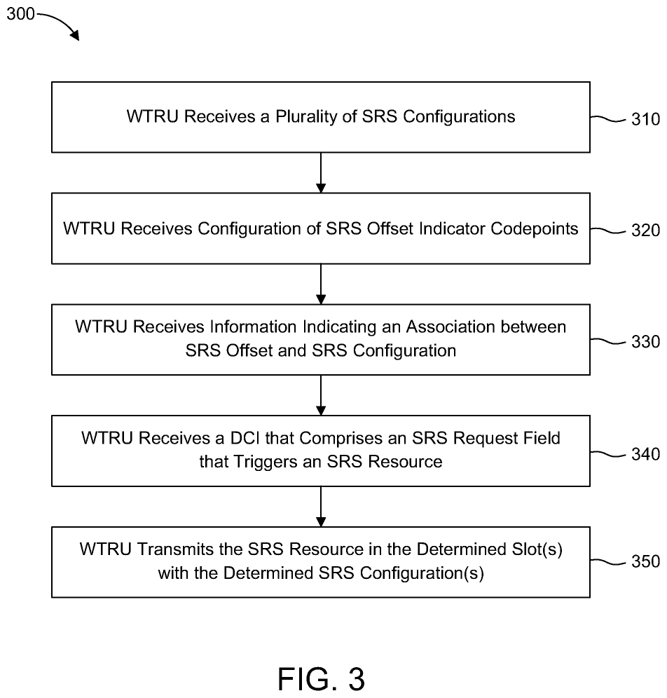

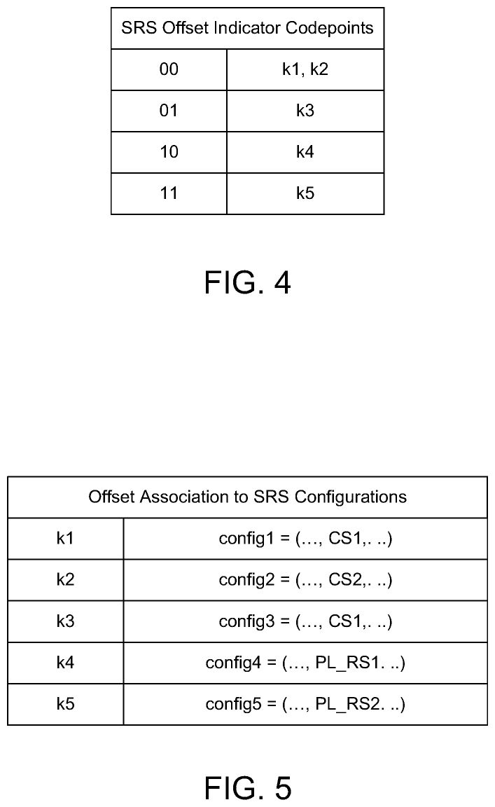

FIG. 3 shows an example method 300 of dynamic joint SRS configuration and offset triggering. A WTRU may receive a plurality of SRS configurations 310. Each SRS configuration may be associated with parameters and the parameters may be different. The parameters may comprise, for example, a cyclic shift (CS) and a path loss reference signal (PL_RS). For example, a first SRS configuration (config1) may comprise at least CS1; a second SRS configuration (config2) may comprise at least CS2; a third SRS configuration (config3) may comprise at least CS1; a fourth SRS configuration (config4) may comprise at least PL_RS1; and a fifth SRS configuration (config5) may comprise at least PL_RS2. The WTRU may receive a configuration of an SRS offset indicator codepoint bit field where a codepoint may be associated with one or multiple SRS time offsets 320. For example, as shown in FIG. 4, codepoint bit field 00 is associated with the pair of offsets (k1, k2), and other codepoints 01, 10, and 11 are associated with single offset values k3, k4, and k5 respectively. The WTRU may receive information indicating an association between an SRS offset and an SRS configuration 330. For example, as shown in FIG. 5, offset k1 is associated with an SRS configuration (config1) with CS1, k2 is associated with an SRS configuration (config2) with CS2, k3 is associated with an SRS configuration (config3) with CS1, k4 is associated with an SRS configuration (config4) with PL_RS1, and k5 is associated with an SRS configuration (config5) with PL_RS2. Other parameter sets may be configured such as PL_RS indices, sequence indices, comb indices, frequency domain indices, or other SRS parameters. Config3 uses CS1 similar to config1 and only triggers one SRS. Config 4 and 5 use different PL_RS to target different TRPs with different spatial filters. The WTRU may receive downlink control information (DCI) that may comprise an SRS request field that triggers an SRS resource 340. The WTRU may determine an SRS offset indicator codepoint of the triggered SRS resource based on the SRS request field. The WTRU may determine the parameters of the SRS resource based on the SRS offset. For example, the WTRU may receive codepoint 00 in the DCI, which indicates offsets k1 and k2, as shown in FIG. 4. The WTRU may transmit the SRS resource in the determined slot or slots and with the determined SRS configuration or configurations 350. For example, if the WTRU receives codepoint 00 in the DCI, the WTRU transmits the SRS resource in the (n+k1)-th slot with CS1 and transmits the SRS resource in the (n+k2)-th slot with CS2.

The configuration of k values may be RRC configured, or the WTRU may receive a MAC-CE to update or modify the k values associated with the SRS offset indicator codepoints. The RRC configuration or MAC-CE may also update or modify the parameter set configurations associated with each k value.

In an embodiment, a WTRU may receive two separate configurations of SRS offset indicator codepoint tables where one table (i.e. table-1) may have one offset per codepoint and a second enhanced (new) table (i.e. table-2) may be configured with multiple offsets per codepoint. In table-1, codepoint 00 may be associated with k1 with config1, while in table-2, codepoint 00 may be associated with (k1, k2) as shown in FIG. 3. The WTRU may receive an indication (e.g. new bit in a DCI) to toggle between the two tables. For example, if the WTRU receives bit 0, the WTRU may use table-1, and the WTRU may transmit one SRS with config1. If the WTRU receives bit 1, the WTRU may use table-2 and transmit two SRS with (k1, k2) offsets, and config1 and 2, respectively.

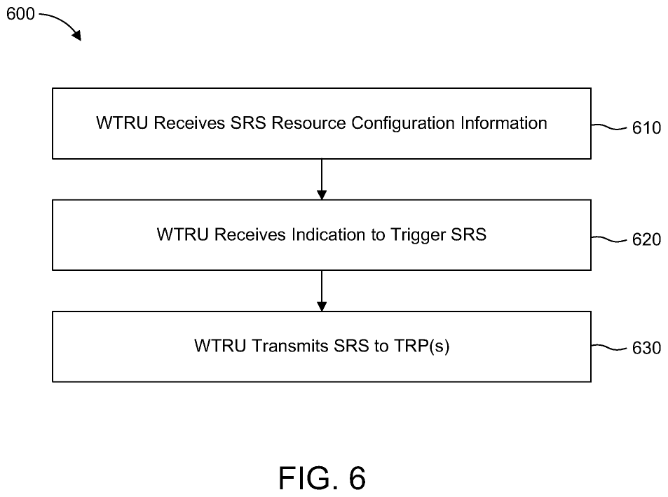

A WTRU may be triggered to transmit an mTRP aperiodic SRS (AP-SRS) with a dynamic parameter update. FIG. 6 shows an example method 600 of mTRP SRS transmission. A WTRU may receive SRS resource configuration information 610. The SRS resource configuration information may comprise configuration of one or more AP-SRS resources. The SRS resource configuration information may comprise a set of parameters for each AP-SRS resource. The set of parameters may comprise, for example, a cyclic shift (CS), a comb value, a sequence related parameter such as sequence ID or group ID, a port configuration, a path loss reference signal (PL RS), and and/or a SRS power control parameter. The WTRU may receive a command or indication to trigger an AP-SRS 620. The command or indication may be received in, for example, a DCI or a MAC-CE. The command or indication may indicate, for example, an AP-SRS resource, a first parameter for a first TRP (TRP1) and a second parameter for a second TRP (TRP1). The WTRU may transmit an AP-SRS to a TRP 630. The WTRU may transmit an AP-SRS to each TRP (e.g. TRP1 and TRP2) using the indicated AP-SRS resources and the indicated parameter for each respective TRP.

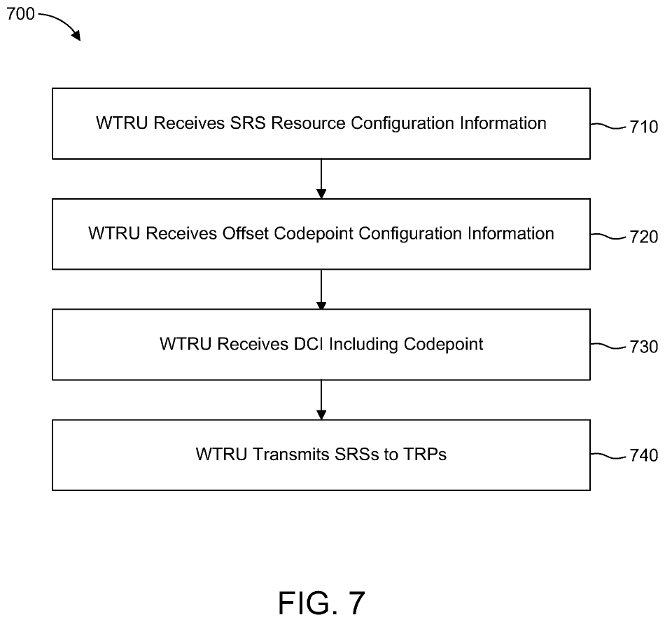

A WTRU may transmit mTRP AP-SRS with dynamic multi-offset triggering associated with a plurality of parameters. FIG. 7 shows an example method 700 of mTRP SRS transmission. A WTRU may receive SRS configuration information 710. The SRS configuration information may indicate a configuration of a plurality of AP-SRS resources. Each AP-SRS resource may be associated with a TRP. The WTRU may receive information indicating an offset codepoint configuration 720. A codepoint may be associated to a plurality of time offsets. Each time offset may be associated to an AP-SRS resource. The WTRU may receive information (e.g. a DCI) that includes a codepoint 730. The WTRU may transmit a plurality of SRS 740. Each SRS transmission may be to a different TRP and may be based on a time offset and associated TRP.

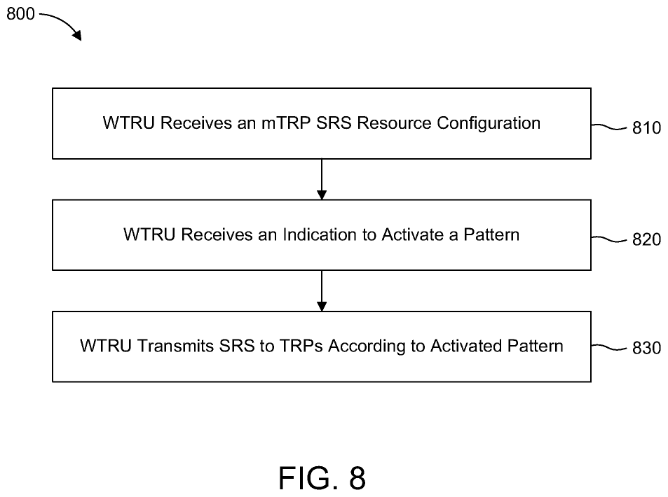

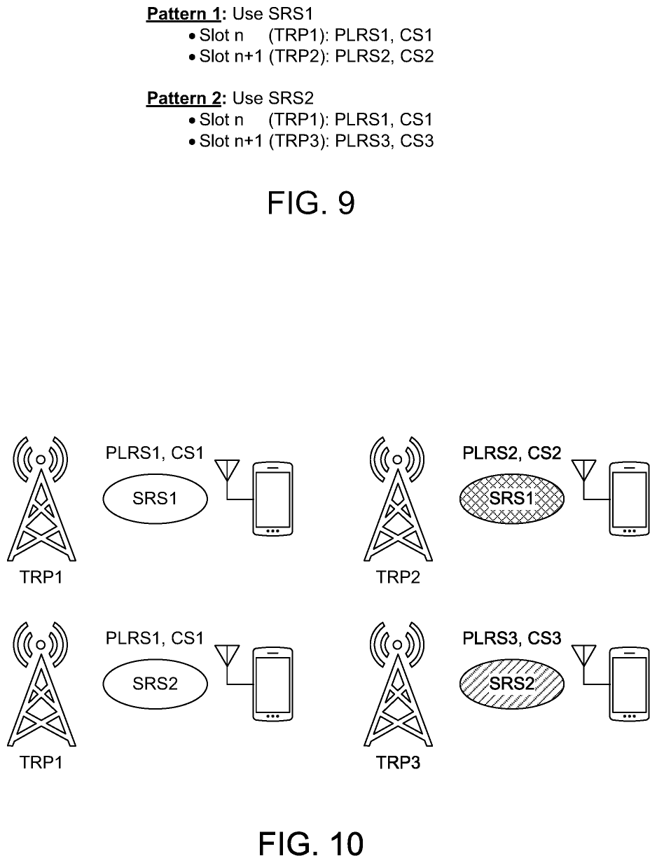

FIG. 8 shows an example method 800 of mTRP SRS transmission. A WTRU may receive an mTRP SRS resource configuration 810. The WTRU may receive the mTRP SRS resource configuration via RRC signaling. The mTRP resource configuration may comprise an SRS resource set. The SRS resource set may comprise one or more SRS resources (e.g. SRS1, SRS2). The SRS resource set may comprise a plurality of path loss reference signals (PL RS) (e.g. PLRS1, PLRS2, PLRS3). The mTRP resource configuration may comprise an information indicating an association of at least two PL RS to each SRS resource (e.g. SRS1 may be associated with PLRS1 and PLRS2; SRS2 may be associated with PLRS1 and PLRS3). The mTRP resource configuration may comprise a set of time-based mTRP patterns associated with the resource set (e.g. Pattern1, Pattern2, etc.). Each time instance (e.g. a slot) of each pattern may be associated with a TRP. FIG. 9 shows an example of two time-based patterns. Pattern 1 indicates the use of SRS1 resource. Pattern 1 indicates using a first slot (slot n) for transmitting an SRS using SRS1 resource to TRP1, using power control based on PLRS1 and using CS1. Pattern 1 indicates using a second slot (slot n+1) for transmitting an SRS using SRS1 to TRP2, using power control based on PLRS2 and using CS2. Pattern 2 indicates the use of SRS2. Pattern 2 indicates using a first slot (slot n) for transmitting an SRS using SRS2 resource to TRP1, using power control based on PLRS1 and using CS1. Pattern 2 indicates using a second slot (slot n+1) for transmitting an SRS using SRS2 resource to TRP3, using power control based on PLRS3 and using CS3. The mTRP resource configuration may comprise one or more SRS parameters associated with each TRP or time instance. The parameters may be, for example, a cyclic shift (CS), a comb, a time offset, a sequence index, and/or a group index. The WTRU may receive a command or indication to activate a pattern from the set of patterns 820. The command may be received in a DCI or MAC-CE. The WTRU may determine which pattern to activate from the set of patterns. For example, the DCI may comprise a field that indicates one pattern out of the set of patterns. For example, the MAC-CE may comprise a command to activate one pattern from the set of patterns. The WTRU may transmit an SRS to the TRPs according to the activated pattern 830. The WTRU may transmit a first SRS in a first time instance using a first SRS resource of the one or more SRS resources and a first SRS parameter of the one or more SRS parameters. The first SRS resource and the first SRS parameter may be determined based on the activated time-based pattern. The first SRS may be transmitted to a first TRP. The WTRU may transmit a second SRS in a second time instance that is different than the first time instance using the first SRS resource and a second SRS parameter. The second SRS parameter may be determined based on the activated time-based pattern. The second SRS may be transmitted to a second TRP. For example, as shown in FIG. 10, based on the patterns from FIG. 9, if pattern 1 is activated, the WTRU transmits an SRS using SRS1 resource to TRP1 in slot n using power control based on PLRS1 and using cyclic shift CS1 and transmits an SRS using SRS1 resource to TRP2 in slot n+1 using power control based on PLRS2 and using cyclic shift CS2. If pattern 2 is activated, the WTRU transmits an SRS using SRS2 resource to TRP1 in slot n using power control based on PLRS1 and using cyclic shift CS1 and transmits an SRS using SRS2 resource to TRP3 in slot n+1 using power control based on PLRS3 and using cyclic shift CS3.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for multiple transmission and reception point (mTRP) transmission, for use in a wireless transmit/receive unit (WTRU), the method comprising:
receiving configuration information indicating a sounding reference signal (SRS) resource set that includes one or more SRS resources, one or more SRS parameters, and one or more time-based patterns;
receiving an indication to activate a time-based pattern of the one or more time-based patterns;
transmitting a first SRS in a first time instance using a first SRS resource of the one or more SRS resources and a first SRS parameter of the one or more SRS parameters, wherein the first SRS resource and the first SRS parameter are determined based on the activated time-based pattern; and
transmitting a second SRS in a second time instance that is different than the first time instance using the first SRS resource and a second SRS parameter, wherein the second SRS parameter is determined based on the activated time-based pattern.

2. The method of claim 1, wherein the configuration information further indicates a plurality of pathloss reference signals (PL RS).

3. The method of claim 2, wherein the configuration information further indicates an association between each SRS resource and a respective subset of the plurality of PL RS.

4. The method of claim 2, wherein the first SRS is transmitted with a transmit power determined based on a PL RS of the plurality of PL RS, wherein the PL RS is determined based on the activated time-based pattern.

5. The method of claim 2, wherein the second SRS is transmitted with a transmit power determined based on a PL RS of the plurality of PL RS, wherein the PL RS is determined based on the activated time-based pattern.

6. The method of claim 1, wherein the first SRS parameter and the second SRS parameter are a respective first and second cyclic shift (CS) and the first and second CS are different.

7. The method of claim 1, wherein the indication to activate a time-based pattern is received in downlink control information (DCI) or a medium access control (MAC) control element (CE).

8. The method of claim 1, further comprising:
determining a time-based pattern to activate based on the indication to activate a time-based pattern.

9. The method of claim 1, wherein the one or more SRS parameters comprises a cyclic shift, a comb, a time offset, a sequence index, or a group index.

10. The method of claim 1, wherein the first SRS parameter is based on the activated time-based pattern and the first time instance and the second SRS parameter is based on the activated time-based pattern and the second time instance.

11. A wireless transmit/receive unit (WTRU) comprising:
a receiver configured to receive configuration information indicating a sounding reference signal (SRS) resource set that includes one or more SRS resources, one or more SRS parameters, and one or more time-based patterns;
the receiver is further configured to receive an indication to activate a time-based pattern of the one or more time-based patterns;
a transmitter configured to transmit a first SRS in a first time instance using a first SRS resource of the one or more SRS resources and a first SRS parameter of the one or more SRS parameters, wherein the first SRS resource and the first SRS parameter are determined based on the activated time-based pattern; and
the transmitter is further configured to transmit a second SRS in a second time instance that is different than the first time instance using the first SRS resource and a second SRS parameter, wherein the second SRS parameter is determined based on the activated time-based pattern.

12. The WTRU of claim 11, wherein the configuration information further indicates a plurality of pathloss reference signals (PL RS).

13. The WTRU of claim 12, wherein the configuration information further indicates an association between each SRS resource and a respective subset of the plurality of PL RS.

14. The WTRU of claim 12, wherein the first SRS is transmitted with a transmit power determined based on a PL RS of the plurality of PL RS, wherein the PL RS is determined based on the activated time-based pattern.

15. The WTRU of claim 12, wherein the second SRS is transmitted with a transmit power determined based on a PL RS of the plurality of PL RS, wherein the PL RS is determined based on the activated time-based pattern.

16. The WTRU of claim 11, wherein the first SRS parameter and the second SRS parameter are a respective first and second cyclic shift (CS) and the first and second CS are different.

17. The WTRU of claim 11, wherein the indication to activate a time-based pattern is received in downlink control information (DCI) or a medium access control (MAC) control element (CE).

18. The WTRU of claim 11, further comprising:
a processor configured to determine a time-based pattern to activate based on the indication to activate a time-based pattern.

19. The WTRU of claim 11, wherein the one or more SRS parameters comprises a cyclic shift, a comb, a time offset, a sequence index, or a group index.

20. The WTRU of claim 11, wherein the first SRS parameter is based on the activated time-based pattern and the first time instance and the second SRS parameter is based on the activated time-based pattern and the second time instance.
